(19) United States
(12) Patent Application Publication
(10) Pub. No.: US 2022/0092096 A1
(43) Pub. Date: Mar. 24, 2022

(54) AUTOMATIC GENERATION OF SHORT NAMES FOR A NAMED ENTITY

(71) Applicant: International Business Machines Corporation, Armonk, NY (US)

(72) Inventors: Zhong Fang Yuan, Xian (CN); Wen Wang, Hai Dian District (CN); Tong Liu, Xian (CN); Si Tong Zhao, Xian (CN); Kun Yan Yin, Ningbo (CN); He Li, Beijing (CN)

(21) Appl. No.: 17/029,779

(22) Filed: Sep. 23, 2020

(51) Int. Cl. G06F 16/33; G06F 16/31; G06N 3/04; G06N 3/08; G06F 40/295

(52) U.S. Cl. CPC G06F 16/3344; G06F 16/31; G06F 40/295; G06N 3/088; G06N 3/0454

(57) ABSTRACT

Embodiments of the present disclosure present and approach for automatic generation of short names for a named entity. According to the approach, a standard text segment is obtained, which indicates a full name of a named entity. At least one feature representation of the standard text segment is extracted. A plurality of variant text segments are generated based on the at least one feature representation using a generative learning network. The plurality of variant text segments indicate a plurality of short names for the named entity, the generative learning network characterizing a generation of variants for an input text segment. The plurality of variant text segments are stored in association with the standard text segment into a data repository.

### BACKGROUND

The present disclosure generally relates to natural language processing techniques and, more particularly, to automatic generation of short names for a named entity.

A short name is a shortened form of a word or phrase of a named entity. It may consist of a group of characters or words taken from the full version of the word or phrase. A short name is also referred to as a shortened name or an abbreviated name. Short names are widely used in written language expressions as they may be used to save space and time, to avoid repetition of long words and phrases, or simply to conform to conventional usage. The styling of short names may be inconsistent and arbitrary and may include many possible variants in different use cases.

### SUMMARY

According to one embodiment of the present disclosure, there is provided a computer-implemented method. According to the method, a standard text segment is obtained, which indicates a full name of a named entity. At least one feature representation of the standard text segment is extracted. A plurality of variant text segments are generated based on the at least one feature representation using a generative learning network. The plurality of variant text segments indicate a plurality of short names for the named entity, the generative learning network characterizing a generation of variants for an input text segment. The plurality of variant text segments are stored in association with the standard text segment into a data repository.

According to a further embodiment of the present disclosure, there is provided a system. The system comprises a processing unit; and a memory coupled to the processing unit and storing instructions thereon. The instructions, when executed by the processing unit, perform acts of the method according to the embodiment of the present disclosure.

According to a yet further embodiment of the present disclosure, there is provided a computer program product being tangibly stored on a non-transient machine-readable medium and comprising machine-executable instructions. The instructions, when executed on a device, cause the device to perform acts of the method according to the embodiment of the present disclosure.

### BRIEF DESCRIPTION OF THE OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to some embodiments of the present disclosure.

FIG. 2 depicts a cloud computing environment according to some embodiments of the present disclosure.

FIG. 3 depicts abstraction model layers according to some embodiments of the present disclosure.

FIG. 4 depicts a block diagram of a system for automatic short-name generation and application according to some embodiments of the present disclosure.

FIG. 5 depicts a block diagram of the short-name generator in the system of FIG. 4 according to some embodiments of the present disclosure.

FIG. 6 depicts a block diagram of a system for network training according to some embodiments of the present disclosure.

FIG. 7 depicts a block diagram of a system for automatic short-name generation and application according to some other embodiments of the present disclosure.

FIG. 8 depicts a flowchart of an example method according to some embodiments of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

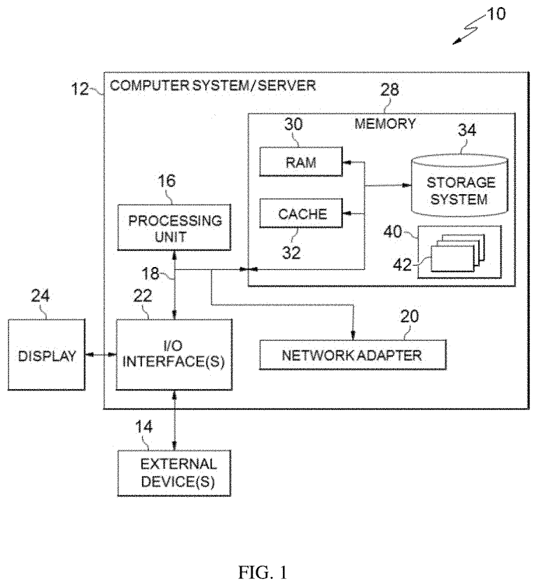

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

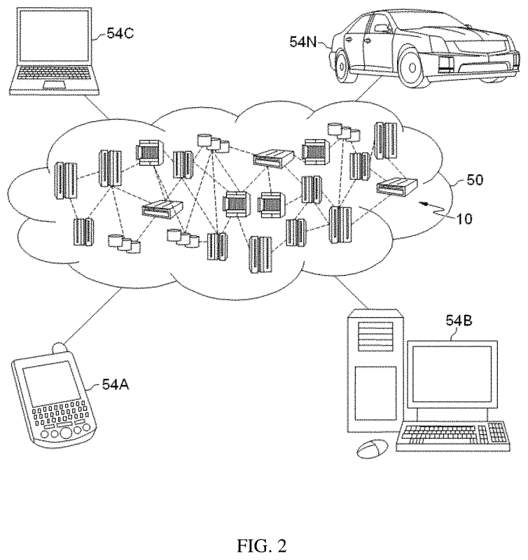

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that cloud computing nodes 10 and cloud computing environment 50 can communicate with any type of computerized device over any type of network and/or network addressable connection (e.g., using a web browser).

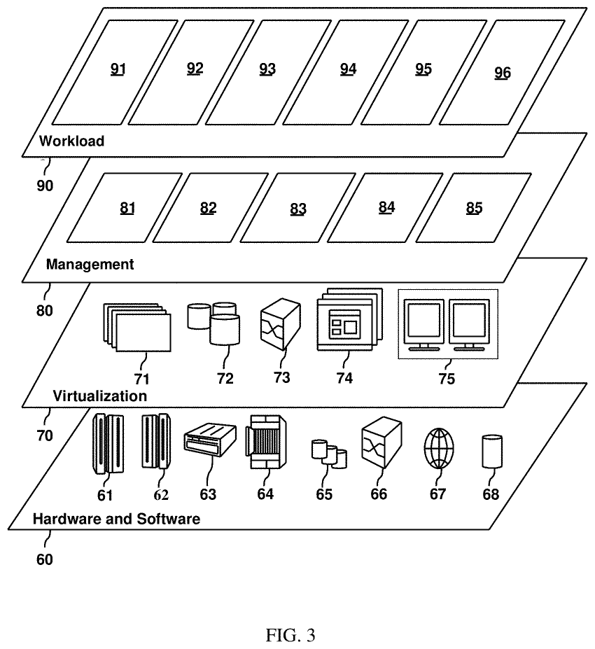

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and short-name generation and application 96. The functionalities of short-name generation and application 96 will be described in the following embodiment of the present disclosure.

As used herein, a “machine learning network” is an artificial intelligence (AI) model, which may also be referred to as a “learning network”, “learning model”, “network model”, or “model.” These terms are used interchangeably hereinafter. A deep learning model is one example machine learning model, examples of which include a “neural network.” A parameter set of the machine learning network is determined through a training phrase of the learning network based on training data. The training process of a machine learning model may be considered as learning, from the training data, an association or mapping between the input and the output. The trained machine learning network can thus characterize an association between an input and its corresponding output. By running the trained machine learning network, a received input can be processed to generate a corresponding output.

Performing machine learning usually involves the following three phrases: a training phase to train a machine learning model with a training dataset by pairing an input with an expected output; an evaluation/test phase to estimate how well the model has been trained by estimating model performance characteristics (e.g., classification errors for classifiers, etc.) using an evaluation dataset and/or a test dataset; and an application phrase to apply the real-world data to the trained machine learning model to get the results.

As mentioned as above, short names are widely used in written language expressions and the styling of short names may include many possible variants in different use cases. Short names of a phrase may comprise abbreviation of tokens or characters, or the combination from the standard name and sometimes even some characters seems totally unrelated with the standard name. For example, “MBA” is a short name for “Master of Business Administration,” and “IBM” is a short name for “International Business Machine Company.” In some language expressions such as the Chinese language expressions, the number of possible short names for a same named entity may be relatively large especially when the corresponding full name is lengthy. For example, regarding the full name of “ [symbol] [symbol] ,” various short names may be used in written expressions, such as “ [symbol] ” which includes a five-word combination of the first, third, eighth, ninth, and last Chinese words of the full name, “ [symbol] ” which includes an eight-word combination of the third, fifth, seventh, and last four words of the full name, and various other combinations.

Lacking the knowledge of the short names may lead to poor performance in many natural language processing tasks with respect to the named entity. For example, in the scenario of information searching, people may input search queries containing short names of a company, organization, product, and the like. Most of the search engines may recognize a short name from an input search query and calculate text similarities between the recognized short name and existing text segments indicating named entities stored in a data repository. The search engines then retrieve some candidate text segments based on the text similarities and filter out search results linked with the candidate text segments. However, if the text segments include a text segment indicating the full name (which may include more characters or words than the short name) or a different short name of the named entity, the calculated text similarity may not be high enough such that the accurate text segment may not be selected as a candidate to filter out the search results. This may result in unsatisfied search performance.

The inventors have found that generally full names of the named entities are stored in the data repository and are linked to data used as search results. There is a small amount of data that are linked to short names of the named entities. For those data with short names identified, only a limited number of common and popular short names are recorded. Upon research and investigation, the inventors have found that addition of short names for named entities can significantly improve the accuracy in various applications including the searching application related to the named entities.

In view of the above, according to embodiments of the present disclosure, there is proposed a solution for automatic generation of short names for a named entity. In this solution, a generative learning network is obtained to characterize a generation of variants for an input text segment. For a standard text segment which indicates a full name of a named entity, at least one feature representation of the standard text segment is extracted and applied into the generative learning network. The generative learning network automatically generates, based on the at least one feature representation, a plurality of variant text segments which indicate short names for the named entity. The standard text segment indicating the full name and the variant text segments indicating the short names are stored into a data repository for future use in applications related to the named entity, such as in searching for data containing the named entity.

Through this solution, by automatically generating short names for a named entity based on its full name, the short name candidates for the full name are enriched and thus can be used to improve the accuracy in applications related to the named entity.

Other advantages of the present disclosure will be described with reference to the example embodiments and the accompanying drawings below. It would be appreciated that Chinese language text illustrated in the accompanying drawings and discussed in some embodiments below are provided as specific examples merely for the purpose of illustration. The embodiments of the present invention can be applied to generate short names for named entities in any other natural language text such as English text, Latin text, and the like.

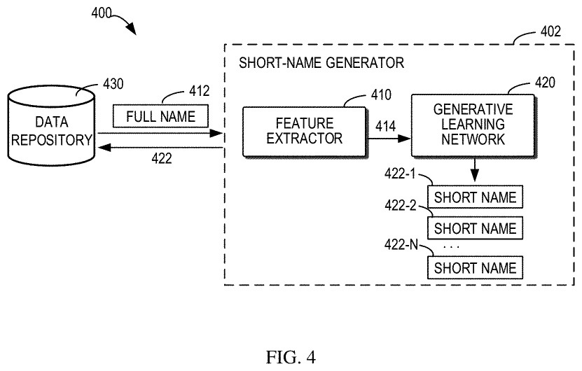

Reference is now first made to FIG. 4, which illustrates a block diagram of a system 400 for automatic short-name generation and application according to some embodiments of the present disclosure. As illustrated, the system 400 comprises a short-name generator 402 which is configured to generate short names for a named entity based on a full name of the named entity.

As used herein, a short name is a shortened form of a word or phrase of a named entity. It may consist of a group of characters or words taken from the full version of the word or phrase. As compared with the full name, the short name may include a smaller number of characters or words. A short name is also referred to as a shorten name or an abbreviated name.

It would be appreciated that the system 400 may be implemented by one or more computing systems or devices having computing and storage capability. For example, the system 400 may be implemented by one or more computing platforms, servers, mainframes, general-purpose computing devices, and/or the like. It would also be appreciated that the components of the short-name generator shown in FIG. 4 may be implemented as one or more software engines, components, or the like, which are configured with logic for implementing the functionality attributed to the particular module. Each component may be implemented using one or more of such software engines, components or the like. The software engines, components, and the like are executed on one or more processors of one or more computing systems or devices and utilize or operate on data stored in one or more storage devices, memories, or the like, on one or more of the computing systems.

As illustrated in FIG. 4, the short-name generator 402 comprises a feature extractor 410 and a generative learning network 420. In operation, the short-name generator 402 is configured for short-name generation for a standard text segment 412 which indicates a full name of a named entity. A named entity is a group of one or more words that identify an entity by name. For example, named entities may include persons, companies, organizations, groups, locations, dates, monetary expressions, and the like. The full name of the named entity is the full and standard version of the name of the corresponding entity. Thus, the standard text segment 412 may include one or more words or a phrase in a certain natural language.

In some embodiments, the standard text segment 412 may be retrieved from a data repository 430 which is configured to store various standard text segments indicating full names of named entities. The stored standard text segments may be collected from various data sources. The short-name generator 402 may be configured to generate short names for one or more named entities based on the corresponding standard text segments stored in the standard text segments according to some embodiments of the present disclosure.

To generate short names, the standard text segment 412 is provided to the feature extractor 410 which is configured to extract one or more feature representations 414 of the standard text segment 412. The one or more feature representations 414 may be in form of a multi-dimensional vector consisting of numerical values, which may thus also be referred to as feature vectors, vectorized representations, features, or the like.

Each of the feature representations 414 can be useful in representing at least one aspect of properties of the standard text segment 412. In some embodiments, the feature extractor 410 may be configured to extract one or more feature representations 414 of the standard text segment 412 that represent one or more useful properties of the standard text segment 412 in generating a short name(s) for the corresponding named entity.

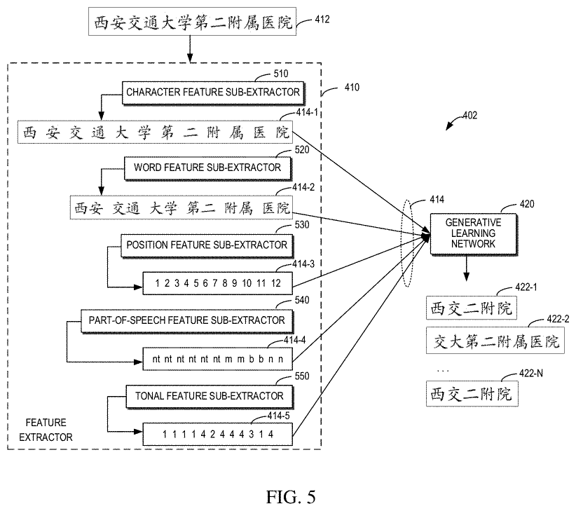

In an embodiment, the feature extractor 410 may be configured to extract one or more feature representations 414 representing one or more linguistic properties of the standard text segment 412. The linguistic properties may be associated with different textual units (e.g., characters or words) comprised in the standard text segment 412, relative positioning of the textual units, one or more parts-of-speech of one or more words comprised in the standard text segment 412, and/or the like. Alternatively, or in addition, the feature extractor 410 may be configured to extract one or more feature representations 414 representing one or more acoustic properties of the textual units comprised in the standard text segment 412 such as tones of the textual units. It would be appreciated that the above properties are provided as examples. Other properties associated with the standard text segment 412 may also be extracted by the feature extractor. Detailed description related to the extraction of the feature representations will be provided below with reference to FIG. 5.

The one or more extracted feature representations 414 are provided as an input to the generative learning network 420. The generative learning network 420 applied in the short-name generator 402 is a trained learning network or model that can characterize a generation of variants for an input text segment. In the application within the short-name generator 402, the input text segment is the standard text segment 412. The generative learning network 420 is capable of generating, based on the input one or more extracted feature representations 414 of the standard text segment 412, a plurality of variant text segments 422-1, 422-2, . . . , 422-N, where N is an integer larger than one. Each of the variant text segments 422-1, 422-2, . . . , 422-N indicates a different short name for the named entity indicated by the standard text segment 412. For ease of discussion, the variant text segments 422-1, 422-2, . . . , 422-N are collectively or individually referred to as variant text segments 422. As the variant text segments 422 indicate the short names, those text segments may also be referred to as short-name text segments.

A generative learning network or a generative model is productive in that it can be utilized to actively generate one or more variants of an input text segment based on application of one or more feature representations 414 of the input to the generative learning network. In this manner, a generative learning network can be utilized to generate variant(s) of any input even if the generative learning network was not trained based on the input text segment. Accordingly, the generative learning network can be utilized to generate variants for novel input text segments.

There are a variety of model structures that have been devised using deep learning to construct generative learning networks. Some examples for the generative learning network 420 may include a Variational Auto Encoder (VAE), a Generative Adversarial Network (GAN), a Deep Generative Adversarial Network (DGAN), a sequence to sequence (seq2seq) model, a combination thereof, and/or the like. It would be appreciated that the generative learning network 420 may be constructed based on various other model structures as only as the constructed model is capable of generating variants of an input text segment based on a feature representation(s) of the input text segment.

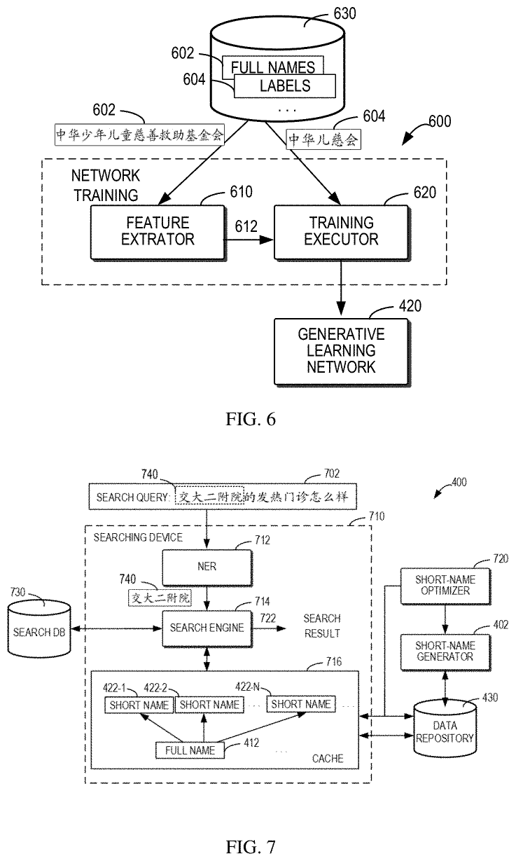

To learn the capability of generating variants for an input text segment in the application of short-name generation, the generative learning network 420 is trained based on training data. The training of the generative learning network 420 will be described in detail with reference to FIG. 6.

The generated variant text segments 422 can be stored in association with the standard text segment 412 for future use in various applications related to the named entity. For example, the variant text segments 422 may be stored into the data repository 430 together with the standard text segment 412. Although one data repository is illustrated, the variant text segments 422 and the standard text segment 412 may be distributed across multiple storage devices/systems, and the scope of the present disclosure is not limited herein. In other examples, the variant text segments 422 and the standard text segment 412 may be in a different data repository than the data repository 430 from which the standard text segment 412 is retrieved.

One example of the applications related to the named entity includes the searching application which will be described in detail below with reference to FIG. 7. As will be described, the enrichment of the short names can significantly improve accuracy of the searching results. Other examples of the applications may include information extraction, knowledge graph building where the variant text segments may be used as auxiliary tags for the named entity, and/or other natural language tasks related to the named entity.

Reference is further made to FIG. 5, which illustrates a block diagram of the short-name generator in the system of FIG. 4 according to some embodiments of the present disclosure. To better understand the short-name generation, FIG. 5 shows a specific example standard text segment 412 in the Chinese langue and example variant text segments 422 generated for this example standard text segment 412. It would be appreciated that those examples are provided for the purpose of illustration only. Other text segments and expressions in other languages may also be applicable.

As illustrated, the feature extractor 410 comprises one or more feature sub-extractors which are configured to extract one or more types of feature representations used as an input to the generative learning network 420.

Specifically, the feature extractor 410 comprises a character feature sub-extractor 510 which is configured to extract a character feature representation 414-1 of one or more characters comprised in the standard text segment 412. A character may indicate a basic textual unit forming a phrase or expression in a certain language. In the Chinese language, a character may comprise a single Chinese character. In other languages such as in the English or Latin language, a character may include a letter. The character feature representation 414-1 may be determined by embedding an individual character into a vector space to obtain a multi-dimensional vector or embedding. In some examples, the character feature representation 414-1 may be obtained by performing one-hot encoding or any other encoding on the respective one or more characters comprised in the standard text segment 412. The character feature representation 414-1 may be a combination of one or more multi-dimensional vectors generated from one or more characters in the standard text segment 412.

The feature extractor 410 also comprises a word feature sub-extractor 520 which is configured to extract a word feature representation 414-2 of one or more words comprised in the standard text segment 412. A word may comprise a character string. In the Chinese language, one or more words of the standard text segment 412 may be obtained by performing word segmentation, and each word may include one or more characters. In the English or Latin language, a word may include a single combination of character(s) that can be represented in writing or speech. The word feature representation 414-2 may be determined by embedding an individual word into a vector space to obtain a multi-dimensional vector or embedding. In some examples, the word feature sub-extractor 520 may apply one or more trained model such as a word2vec model to generate the word feature representation 414-2. The word feature representation 414-2 may be a combination of one or more multi-dimensional vectors generated from one or more words in the standard text segment 412.

It would be appreciated that the definition of characters and words are known in the fields of processing for different natural languages. The character feature representation 414-1 and the word feature representation 414-2 can characterize the semantic of the standard text segment 412 from both the character-level and the word-level. It would also be appreciated that although the character-level and word-level feature representations 414-1, 414-2 are described here, the feature extractor 410 may be configured to alternatively or additional extract one or more feature representations of one or more other level of textual units divided from the standard text segment 412 in order to explore different levels of semantic of the standard text segment 412.

As illustrated, the feature extractor 410 further comprises a position feature sub-extractor 530 which is configured to extract a position feature representation 414-3 of one or more characters or words comprised in the standard text segment 412. In some embodiments, the position feature representation 414-3 may indicate relative positioning of individual characters (such as Chinese characters) or relative positioning of individual words (such as in English or Latin language). As an example, the position feature representation 414-3 may indicate the ordered sequence of the characters or words (such as 1, 2, 3, 4, 5, 6, 7, 8, 9, 10, 11, 12 each indicating the ordering of the Chinese characters in the illustrated Chinese standard text segment 412). The position feature representation 414-3 can help capture the context of the individual characters or words within the standard text segment 412, which may help understand the semantic of the standard text segment 412.

The feature extractor 410 is further illustrated to include a part-of-speech feature sub-extractor 540 which is configured to extract a part-of-speech feature representation 414-4. The part-of-speech feature representation 414-4 indicates a part-of-speech or parts-of-speech of one or more characters or words comprised in the standard text segment 412. In some embodiments, the part-of-speech feature representation 414-4 may indicate one or more parts-of-speech of one or more individual characters (such as Chinese characters) or parts-of-speech of one or more individual words (such as in English or Latin language). As some examples, the parts of speech in natural languages may include nouns, pronouns, verbs, adjectives, adverbs, conjunctions, prepositions, interjections, numerical, quantities, attributives, and the like. The classification of the parts-of-speech may be different depending on natural languages and possible depending on the desired classification granularity for a same natural language.

The part-of-speech feature sub-extractor 540 may identify the part-of-speech or parts-of-speech of the character(s) or word(s) in the standard text segment 412 and then generate a part-of-speech feature representation 414-4 to indicate the identified part-of-speech or parts-of-speech. The part-of-speech feature representation 414-4 may help facilitate the generation of the short names because people may choose one or more nouns and possibly one or more attributives contained in a full name to generate the short names.

In the example illustrated in FIG. 5, the first six annotations of “nt” illustrated in the part-of-speech feature representation 414-4 indicate that the first six Chinese characters in the example standard text segment 412 are nouns indicating organization names, the seventh and eighth annotations “m” indicate that the seventh and eighth Chinese characters are numerical characters, the ninth and tenth annotations “b” indicate that the ninth and tenth Chinese characters are attributives, and the last two annotations “n” indicate that the last two Chinese characters are nouns.

The feature extractor 410 is further illustrated to include a tonal feature sub-extractor 550 which is configured to extract a tonal feature representation 414-5. The tonal feature representation 414-5 indicates a tone of the at least one character or word comprised in the standard text segment 412. The tones are important for tonal languages such as Chinese, Thai, Vietnamese, or the like because a different tone can often completely change a character or a word. For example, in the Chinese language, a Chinese character may potentially have four or five tones which may be represented as 0, 1, 2, 3, and 4. The tonal feature representation 414-5 may help facilitate the generation of the short names because typically the short names widely used are those that are catchy. The tonal feature representation 414-5 may be generated to indicate the identified tone(s) of the character(s) or word(s) in the standard text segment 412, such as those represented by 1 1 1 1 4 2 4 4 4 3 1 4.

Although five types of feature representations 414-1 to 414-5 for the standard text segment 412 are provided above, in some embodiments, the extraction of one or more of the five types of feature representations 414-1 to 414-5 may be omitted. In such case, the corresponding feature sub-extractor(s) may then be omitted from the feature extractor 410. In some embodiments, the feature extractor 410 may be configured to extract one or more additional or alternative feature representations other than those illustrated in FIG. 5. For example, in addition to the tonal feature representation, the feature extractor 410 may alternatively or additionally one or more feature extractor to extract one or more other acoustic feature representations indicating other acoustic properties of the standard text segment 412. Examples of other acoustic properties may include, but are not limited to a spectral shape, pitch, duration, Mel-frequency spectral coefficients, fundamental frequency, and/or the like. The acoustic properties may be recognized from a recorded speech of the standard text segment 412.

One or more representations of the feature representations 414-1 to 414-5 that are extracted from the standard text segment 412 are provided as an input to the generative learning network 420. The generative learning network 420 processes the one or more feature representations 414 to generate a plurality of variant text segments 422 indicating short names of the named entity. FIG. 5 illustrates some example variant text segments 422. As can be seen, the variant text segments 422 comprise different combinations of Chinese characters selected from the standard text segment 412.

In some embodiments, the generative learning network 420 may be configured to generate a set of candidate variant text segments and also provides corresponding degrees of confidence for the set of candidate variant text segments. Each candidate variant text segment indicates a candidate short name for the named entity. A degree of confidence for a certain candidate variant text segment indicates may be a value selected from a predetermined value range, such as a range from 0 to 1. The higher the degree of confidence, the more the probability that the certain candidate variant text segment indicates an appropriate short name for the named entity.

In some embodiments, the plurality of variant text segments 422-1, 422-2, . . . , 422-N may be selected from the set of candidate variant text segments based on the set of degrees of confidence. In an example, the set of candidate variant text segments may be sorted based on their corresponding degrees of confidence. A predetermined number (e.g., N) of top variant text segments 422 may be selected from all the sorted candidate variant text segments. In another example, candidate variant text segments having degrees of confidence higher than a predetermined confidence threshold may be selected as the variant text segments 422. The plurality of variant text segments 422 may be selected from the candidate variant text segments according to any other manners and the scope of the present disclosure is not limited in this regard.

The application of the generative learning network 420 has been discussed above. The generative learning network 420 may be provided into the application phase after being trained based on a training dataset. FIG. 6 illustrates a block diagram of a system 600 for network training according to some embodiments of the present disclosure. The system 600 is configured to train the generative learning network 420 which is capable of characterizing a generation of variants from an input text segment.

It would be appreciated that the system 600 may be implemented by one or more computing systems or devices having computing and storage capability. For example, the system 600 may be implemented by one or more computing platforms, servers, mainframes, general-purpose computing devices, and/or the like. It would also be appreciated that the components of the short-name generator shown in FIG. 4 may be implemented as one or more software engines, components, or the like, which are configured with logic for implementing the functionality attributed to the particular module. Each component may be implemented using one or more of such software engines, components or the like. The software engines, components, and the like are executed on one or more processors of one or more computing systems or devices and utilize or operate on data stored in one or more storage devices, memories, or the like, on one or more of the computing systems. In some embodiments, the systems 400 and 600 may be implemented in a same computing platform.

The training of the generative learning network 420 is based on a training dataset which may be stored in a training database 630 in FIG. 6. The training dataset for the generative learning network 420 may comprise a plurality of training text segments 602 indicating full names of training named entities and a plurality of labels 604 associated with the training text segments. Each label indicates a ground-truth short name for the corresponding training named entity. The training text segments 602 mat include any available standard text segments indicating full names of named entities. The training text segments 602 may include one or more of the standard text segments stored in the data repository 430 or may be totally different from the stored standard text segments.

By utilizing the generative learning network, the complete set of short names for a certain named entity is not required in the training phrase. One ground-truth short name may be enough for the generative learning network 420 to learn how to generate a plurality of variant text segments indicating respective short names. As such, it is possible to build the short-name generator 402 based on a small data collection.

As specifically illustrated, the system 600 comprises a feature extractor 610 and a training executor 620. The feature extractor 610 may be configured to extract one or more feature representations 612 of a training text segment 602. For the purpose of illustration only, one example training text segment 602 in the Chinese langue is illustrated in FIG. 6 as an input to the feature extractor 610. The one or more feature representations 612 may be similar to those as discussed above. The detailed description is omitted for the purpose of brevity.

The one or more feature representations 612 and a label 604 associated with the current training text segment 602 may be used by the training executor 620, to train the generative learning network 420. The label 604 may be used supervised information such that the generative learning network 420 may learn to generate variant text segments indicating short names similar to the ground-truth short name of the label 604. For the purpose of illustration only, one example label 604 for the example training text segment 602 is illustrated in FIG. 6 as an input to the feature extractor 610. A number of other training text segments 602 and their associated labels 604 may also be used in a similar way to train the generative learning network 420.

The training executor 620 may employ various model training methods, either existing or to be developed in the future, in training the generative learning network 420. During the model training process, the training executor 620 may update parameters of the generative learning network 420 iteratively until the generative learning network 420 can characterize a generation of variants from an input text segment. After the training is completed, the trained generative learning network 420 can generate a number of variant text segments indicating short names based on a feature representation(s) extracted from a standard text segment indicating a full name.

In some embodiments, as mentioned above, the stored variant text segments 422 indicating the short names and the standard text segments indicating the full name can be used in a search application related to the named entity. The automatic short-name generation by the short-name generator 402 can be used to generate short names for long tail data which are not covered in an existing dataset for a search engine.

FIG. 7 illustrates a block diagram of the system 400 for automatic short-name generation and application according to some other embodiments of the present disclosure. In the illustrated embodiment, the system 400 further comprises a searching device 710 which is configured to generate a search result as a response to a search query.

Specifically, the searching device 710 receives a search query 702. For the purpose of illustration only, one example search query 702 in the Chinese langue is illustrated in FIG. 6, without suggesting any limitation to the scope of the present disclosure. The searching device 710 comprises a named entity recognition (NER) module 712 and a search engine 714.

The NER module 712 is configured to perform NER on the search query 702 in order to recognize, from the search query 702, one or more query text segments 740 indicating a name(s) of a query named entity/entities. Depending on the actual search queries received, a query text segment 740 may indicate a full name or a short name of a query named entity. In the illustrated example, the NER module 712 recognizes a query text segment 740 consisting of the first five Chinese characters in the search query 702. This query text segment 740 indicates a short name of the named entity. In some example, more than one query text segment 740 may be recognized from a search query.

The query text segment(s) 740 is provided to the search engine 714. The search engine 714 is configured to perform matching between each query text segment 740 and a variety of text segments stored in the data repository 430. The stored text segments may include standard text segments 412 indicating full names and variant text segments 422 indicating short names of various named entities. In some embodiments, in order to speed up the searching, the standard text segments 412 and variant text segments 422 in the data repository 430 may be stored into a cache 716 of the searching device 710, although such caching may not be necessary. It would be appreciated that although one standard text segment 412 and its associated variant text segments 422 are illustrated to be cached in the cache 716, standard text segments and associated variant text segments for various other named entities may also be cached.

The search engine 722 may determine which query text segment 740 matches with one or more of the standard text segments 412 or variant text segments 422 by, for example, calculating their text similarities and/or applying other matching algorithms. If the search engine 722 determines that the query text segment 740 matches with any one of the standard text segments 412 or variant text segments 422, the search engine 714 may determine a search result 722 for the search query 702 based on the matched text segment.

In the searching application, the standard text segments 412 and variant text segments 422 may be linked to a dataset associated with the named entity. The dataset may include data crawled or recorded from various data sources, such as web pages, documents, images, and/or other data that at least partially describes, mentions, or otherwise relates to the named entity with its full name and/or short name(s). Such a dataset may be stored in a search database 730. The search result 722 may be determined from the dataset stored in the search database 730.

It would be appreciated that since the query text segment 740 may be a part of the search query 702, the search engine 714 may determine the search result from various data contained in the dataset based on other searching criterion. The scope of the present disclosure is not limited in this regard. With the addition of the variant text segments 422 automatically generated by the short-name generator 402, the searching accuracy can be significantly improved based on the enriched text segments, especially when the search queries are provided for the named entities using their short names.

In some embodiments, the system 400 may further comprise a short-name optimizer 720 which is configured to optimize short names generated for a named entity. For a certain standard text segment 412, the short-name optimizer 720 is configured to determine a plurality of hit frequencies for the plurality of variant text segments 422 in searching for the named entity. A hit frequency may indicate how often a variant text segment 422 matches with a query text segment in a search query within a time window or among a number of search queries. In some embodiments, a hit frequency may be determined based on one or more of the following: a hit rate or a miss rate of the variant text segment 422 in the cache 716, least recently used (LRU), most recently used (MRU), least frequently used (LFU), most frequently used (MFU), pseudo-LRU (PLRU), and/or the like.

The short-name optimizer 720 is further configured to discard at least one of the plurality of variant text segments 422 for the named entity based on the plurality of hit frequencies. Specifically, the one or more variant text segments 422 with a relative low hit frequency may be discarded. Thus, as compared with the un-discarded variant text segments 422, the discarded variant text segment(s) 422 has lower hit frequencies.

A low hit frequency may imply that the short name indicated by the automatically generated variant text segment 422 is rarely used in real-life applications. Thus, such a variant text segment 422 may be discarded. In some examples, one or more variant text segments 422 having the lowest hit frequency/frequencies may be discarded. In some examples, the short-name optimizer 720 may discard one or more variant text segments 422 having the hit frequency/frequencies lower than a predetermined frequency threshold.

The short-name optimizer 720 may discard the one or more variant text segment 422 from the cache 716 in order to save the storage space of the cache 716. Alternatively, or in addition, the short-name optimizer 720 may one or more variant text segment 422 from the data repository 430.

In some embodiments, in addition to optimize the generated variant text segments 422, the short-name optimizer 720 may be further configured to optimize the performance of the short-name generator 402. In such embodiments, for a certain standard text segment 412, the short-name optimizer 720 may be configured to select one of the plurality of generated variant text segments 422 based on their hit frequencies. The short-name optimizer 720 may select the variant text segment 422 with a relatively high hit frequency. Thus, as compared with at least one unselected variant text segment 422, the selected variant text segment 422 has a higher hit frequency. In an example, the short-name optimizer 720 may select the variant text segment 422 with the highest variant text segment.

The selected variant text segment 422 may be provided as a label for the standard text segment 412 in re-training of the generative learning network 420 used in the short-name generator 402. Such a label may indicate a ground-truth short name for the named entity. If a sufficient amount of new training data are collected during the application of the generative learning network 420, such as the standard text segments and their labels, the generative learning network 420 may be re-trained by the system 600 based on the new training data.

The re-training of the generative learning network 420 may involve fine-tuning of the previously trained parameter set. The label obtained from the variant text segment 422 with the relatively high hit frequency may indicate that the corresponding short name is frequently used for the named entity. By re-training the generative learning network 420 based on such more accurate label, the generative learning network 420 may be enhanced to generate more accurate short names in following usage.

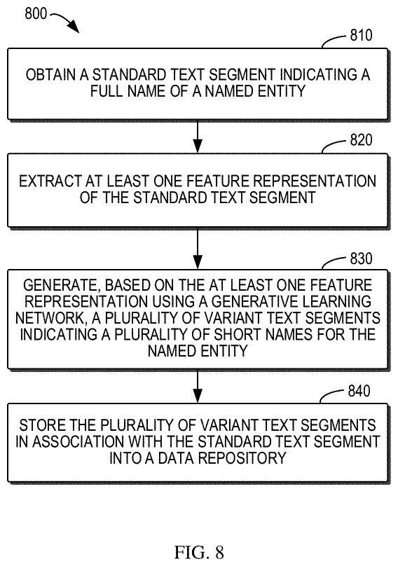

FIG. 8 shows a flowchart of an example method 800 according to some embodiments of the present disclosure. The method 800 can be implemented at the system 400 as shown in FIG. 4 and FIG. 7. For the purpose of discussion, the method 800 will be described from the perspective of the tree execution subsystem 520.

At block 810, the system 400 (for example, the short-name generator 402) obtains a standard text segment indicating a full name of a named entity. At block 820, the system 400 (for example, the short-name generator 402) extracts at least one feature representation of the standard text segment. At block 830, the system 400 (for example, the short-name generator 402) generates, based on the at least one feature representation using a generative learning network, a plurality of variant text segments indicating a plurality of short names for the named entity. The generative learning network characterizes a generation of variants for an input text segment. At block 840, the system 400 stores the plurality of variant text segments in association with the standard text segment into a data repository.

In some embodiments, the plurality of variant text segments and the standard text segment are linked to a dataset associated with the named entity. The plurality of variant text segments and the standard text segment may be provided for use in a searching application related to the named entity.

Specifically, the system 400 (for example, the searching device 710) may perform named entity recognition on a search query to recognize a query text segment indicating a name of a query named entity. The system 400 (for example, the searching device 710) may further match the query text segment with the plurality of variant text segments and the standard text segment. If the query text segment matches one of the plurality of variant text segments and the standard text segment, the system 400 (for example, the searching device 710) may determine a search result for the search query from the dataset.

In some embodiments, the system 400 (for example, the short-name optimizer 720) may determine a plurality of hit frequencies for the plurality of variant text segments in searching for the named entity. The system 400 (for example, the short-name optimizer 720) may discard at least one of the plurality of variant text segments based on the plurality of hit frequencies. The at least one discarded variant text segment may have a lower hit frequency than a hit frequency of at least one un-discarded variant text segment of the plurality of variant text segments.

In some embodiments, the system 400 (for example, the short-name optimizer 720) may select one of the plurality of variant text segments based on the plurality of hit frequencies. The selected variant text segment may have a higher hit frequency than a hit frequency of at least one unselected variant text segment of the plurality of variant text segments. The system 400 (for example, the short-name optimizer 720) may provide the selected variant text segment as a label for the standard text segment in re-training of the generative learning network (for example, by the system 600 in FIG. 6). This label may be used to indicate a ground-truth short name for the named entity.

In some embodiments, to extract the at least one feature representation of the standard text segment, the system 400 (for example, the short-name generator 402) may extract at least one of the following: a character feature representation of at least one character comprised in the standard text segment, a word feature representation of at least one word comprised in the standard text segment, a position feature representation of a position of the at least one character or word within the standard text segment, a tonal feature representation indicating a tone of the at least one character or word comprised in the standard text segment, and a part-of-speech feature representation indicating a part-of-speech of the at least one character or word comprised in the standard text segment.

In some embodiments, to generate the plurality of variant text segments, the system 400 (for example, the short-name generator 402) may generate a set of candidate variant text segments and a set of degrees of confidence for the set of candidate variant text segments based on the at least one feature representation, and select the plurality of variant text segments from the set of candidate variant text segments based on the set of degrees of confidence.

In some embodiments, the generative learning network may be trained (for example, by the system 600 in FIG. 6) based on a training dataset comprising a plurality of training text segments indicating full names of training named entities and a plurality of labels. The plurality of labels respectively indicate ground-truth short names for the training named entities.

It should be noted that the processing of automatic short-name generation according to embodiments of this disclosure could be implemented by computer system/server 12 of FIG. 1. In some embodiments, the system 400 or one or more components of the system 400 could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, by one or more processors, a standard text segment indicating a full name of a named entity;
extracting, by the one the one or more processors, at least one feature representation of the standard text segment;
generating, by the one or more processors, a plurality of variant text segments based on the at least one feature representation using a generative learning network, the plurality of variant text segments indicating a plurality of short names for the named entity, the generative learning network characterizing a generation of variants for an input text segment; and
storing, by the one or more processors, the plurality of variant text segments in association with the standard text segment into a data repository.

2. The computer-implemented method of claim 1, wherein the plurality of variant text segments and the standard text segment are linked to a dataset associated with the named entity, the method further comprising:
performing, by the one or more processors, named entity recognition on a search query to recognize a query text segment indicating a name of a query named entity;
matching, by the one or more processors, the query text segment with the plurality of variant text segments and the standard text segment; and
in accordance with a determination that the query text segment matches one of the plurality of variant text segments and the standard text segment, determining, by the one or more processors, a search result for the search query from the dataset.

3. The computer-implemented method of claim 1, further comprising:
determining, by the one or more processors, a plurality of hit frequencies for the plurality of variant text segments in searching for the named entity; and
discarding, by the one or more processors, at least one of the plurality of variant text segments based on the plurality of hit frequencies, the at least one discarded variant text segment having a lower hit frequency than a hit frequency of at least one un-discarded variant text segment of the plurality of variant text segments.

4. The computer-implemented method of claim 1, further comprising:
determining, by the one or more processors, a plurality of hit frequencies for the plurality of variant text segments in searching for the named entity;
selecting, by the one or more processors, one of the plurality of variant text segments based on the plurality of hit frequencies, the selected variant text segment having a higher hit frequency than a hit frequency of at least one unselected variant text segment of the plurality of variant text segments; and
providing, by the one or more processors, the selected variant text segment as a label for the standard text segment in re-training of the generative learning network, the label indicating a ground-truth short name for the named entity.

5. The computer-implemented method of claim 1, wherein extracting the at least one feature representation of the standard text segment comprises:
extracting, by the one or more processors, at least one of the following:
a character feature representation of at least one character comprised in the standard text segment,
a word feature representation of at least one word comprised in the standard text segment,
a position feature representation of a position of the at least one character or word within the standard text segment,
a tonal feature representation indicating a tone of the at least one character or word comprised in the standard text segment, and
a part-of-speech feature representation indicating a part-of-speech of the at least one character or word comprised in the standard text segment.

6. The computer-implemented method of claim 1, wherein generating the plurality of variant text segments comprises:
generating, by the one or more processors, a set of candidate variant text segments and a set of degrees of confidence for the set of candidate variant text segments based on the at least one feature representation; and
selecting, by the one or more processors, the plurality of variant text segments from the set of candidate variant text segments based on the set of degrees of confidence.

7. The computer-implemented method of claim 1, wherein the generative learning network is trained based on a training dataset comprising a plurality of training text segments indicating full names of training named entities and a plurality of labels, the plurality of labels indicating ground-truth short names for the training named entities.

8. A computer system comprising:
one or more processing units; and
a memory coupled to the one or more processing units and storing instructions thereon, the instructions, when executed by the one or more processing units, performing acts comprising:
obtaining a standard text segment indicating a full name of a named entity;
extracting at least one feature representation of the standard text segment;
generating, based on the at least one feature representation using a generative learning network, a plurality of variant text segments indicating a plurality of short names for the named entity, the generative learning network characterizing a generation of variants for an input text segment; and
storing the plurality of variant text segments in association with the standard text segment into a data repository.

9. The computer system of claim 8, wherein the plurality of variant text segments and the standard text segment are linked to a dataset associated with the named entity, the acts further comprising:
performing named entity recognition on a search query to recognize a query text segment indicating a name of a query named entity;
matching the query text segment with the plurality of variant text segments and the standard text segment; and
in accordance with a determination that the query text segment matches one of the plurality of variant text segments and the standard text segment, determining a search result for the search query from the dataset.

10. The computer system of claim 8, wherein the acts further comprise:
determining a plurality of hit frequencies for the plurality of variant text segments in searching for the named entity; and
discarding at least one of the plurality of variant text segments based on the plurality of hit frequencies, the at least one discarded variant text segment having a lower hit frequency than a hit frequency of at least one un-discarded variant text segment of the plurality of variant text segments.

11. The computer system of claim 8, wherein the acts further comprise:
determining a plurality of hit frequencies for the plurality of variant text segments in searching for the named entity;
selecting one of the plurality of variant text segments based on the plurality of hit frequencies, the selected variant text segment having a higher hit frequency than a hit frequency of at least one unselected variant text segment of the plurality of variant text segments; and
providing the selected variant text segment as a label for the standard text segment in re-training of the generative learning network, the label indicating a ground-truth short name for the named entity.

12. The computer system of claim 8, wherein extracting the at least one feature representation of the standard text segment comprises:
extracting at least one of the following:
a character feature representation of at least one character comprised in the standard text segment,
a word feature representation of at least one word comprised in the standard text segment,
a position feature representation of a position of the at least one character or word within the standard text segment,
a tonal feature representation indicating a tone of the at least one character or word comprised in the standard text segment, and
a part-of-speech feature representation indicating a part-of-speech of the at least one character or word comprised in the standard text segment.

13. The computer system of claim 8, wherein generating the plurality of variant text segments comprises:
generating a set of candidate variant text segments and a set of degrees of confidence for the set of candidate variant text segments based on the at least one feature representation; and
selecting the plurality of variant text segments from the set of candidate variant text segments based on the set of degrees of confidence.

14. The computer system of claim 8, wherein the generative learning network is trained based on a training dataset comprising a plurality of training text segments indicating full names of training named entities and a plurality of labels, the plurality of labels indicating ground-truth short names for the training named entities.

15. A computer program product being tangibly stored on a non-transient machine-readable medium and comprising machine-executable instructions, the instructions, when executed on a device, causing the device to perform acts comprising:
obtaining a standard text segment indicating a full name of a named entity;
extracting at least one feature representation of the standard text segment;
generating, based on the at least one feature representation using a generative learning network, a plurality of variant text segments indicating a plurality of short names for the named entity, the generative learning network characterizing a generation of variants for an input text segment; and
storing the plurality of variant text segments in association with the standard text segment into a data repository.

16. The computer program product of claim 15, wherein the plurality of variant text segments and the standard text segment are linked to a dataset associated with the named entity, the acts further comprising:
performing named entity recognition on a search query to recognize a query text segment indicating a name of a query named entity;
matching the query text segment with the plurality of variant text segments and the standard text segment; and
in accordance with a determination that the query text segment matches one of the plurality of variant text segments and the standard text segment, determining a search result for the search query from the dataset.

17. The computer program product of claim 15, wherein the acts further comprise:
determining a plurality of hit frequencies for the plurality of variant text segments in searching for the named entity; and
discarding at least one of the plurality of variant text segments based on the plurality of hit frequencies, the at least one discarded variant text segment having a lower hit frequency than a hit frequency of at least one un-discarded variant text segment of the plurality of variant text segments.

18. The computer program product of claim 15, wherein the acts further comprise:
determining a plurality of hit frequencies for the plurality of variant text segments in searching for the named entity;
selecting one of the plurality of variant text segments based on the plurality of hit frequencies, the selected variant text segment having a higher hit frequency than a hit frequency of at least one unselected variant text segment of the plurality of variant text segments; and
providing the selected variant text segment as a label for the standard text segment in re-training of the generative learning network, the label indicating a ground-truth short name for the named entity.

19. The computer program product of claim 15, wherein extracting the at least one feature representation of the standard text segment comprises:
extracting at least one of the following:
a character feature representation of at least one character comprised in the standard text segment,
a word feature representation of at least one word comprised in the standard text segment,
a position feature representation of a position of the at least one character or word within the standard text segment,
a tonal feature representation indicating a tone of the at least one character or word comprised in the standard text segment, and
a part-of-speech feature representation indicating a part-of-speech of the at least one character or word comprised in the standard text segment.

20. The computer program product of claim 15, wherein generating the plurality of variant text segments comprises:
generating a set of candidate variant text segments and a set of degrees of confidence for the set of candidate variant text segments based on the at least one feature representation; and
selecting the plurality of variant text segments from the set of candidate variant text segments based on the set of degrees of confidence.
